(19) United States
(12) Patent Application Publication
(10) Pub. No.: US 2009/0234859 A1
(43) Pub. Date: Sep. 17, 2009

(54) SWARM CREATION IN A VEHICLE-TO-VEHICLE NETWORK

(75) Inventors: Travis M. Grigsby, Austin, TX (US); Steven Michael Miller, Cary, NC (US); Pamela Ann Nesbitt, Tampa, FL (US); Lisa Anne Seacat, San Francisco, CA (US)

Correspondence Address: IBM CORPORATION, 3039 CORNWALLIS RD., DEPT. T81 / B503, PO BOX 12195, RESEARCH TRIANGLE PARK, NC, 27709, US

(73) Assignee: INTERNATIONAL BUSINESS MACHINES CORPORATION, Armonk, NY (US)

(21) Appl. No.: 12/049,458

(22) Filed: Mar. 17, 2008

(51) Int. Cl. G06F 7/06; G06F 17/30

(52) U.S. Cl. 707/10; 707/E17.032

(57) ABSTRACT

In vehicle-to-vehicle networks, the “owner” of the given ad hoc vehicle-to-vehicle network may not be interested in a considerable amount of the data provided by other network participants. The owner may define a subset or swarm of data sources that are to be actively considered by entering subset-defining properties. As data is received from other network participants, environmental properties included in the received data are compared to the subset-defining properties. A network participant is included in the defined subset only if a match is found.

### CROSS-REFERENCES TO RELATED APPLICATIONS

This application is related to United States Patent Application (RSW920070485US1) filed concurrently herewith, to United States Patent Application (RSW920070486US1) filed concurrently herewith, to United States Patent Application (RSW920070488US1) filed concurrently herewith, and to United States Patent Application (RSW920080028US1) filed concurrently herewith.

### BACKGROUND OF THE INVENTION

The present invention relates to vehicle-to-vehicle (V2V) networks and more particularly to creation of a swarm (subset of active data sources) for use by a participant in a vehicle-to-vehicle network.

Efforts have been underway for some time to establish standards for and to develop technology that would allow drivers within limited geographic areas to “talk” to each other by participating in ad hoc vehicle-to-vehicle networks in which audio, video and other data is shared among participating vehicles. It is envisioned that each vehicle participating in such a vehicle-to-vehicle network would be equipped with microphones for capturing audio data that could be shared directly with other vehicles independently of any existing communications networks, such as cellular telephone networks, and with video cameras for capturing video data both for use within the participating vehicle and for sharing with other vehicles participating in the network.

According to one proposal, data would be shared among vehicles using a Dedicated Short Range Communications (DSRC) wireless protocol operating in the 5.9 Gigahertz band that would support direct vehicle-to-vehicle communications over a relatively short range (100 meters-300 meters). The effective size of the network implemented using the DSRC would be significantly greater than the direct vehicle-to-vehicle maximum range, however, since each vehicle could relay data received from another vehicle to still other vehicles within its range. Relayed data could “hop” one vehicle at the time to vehicles progressively further away from the vehicle that was the source of the data.

Vehicle-to-vehicle networks will serve the general purpose of making participating drivers more aware of what is happening around them and a number of specific purposes, including safety-related purposes. Such networks would permit drivers to alert other drivers of traffic slowdowns, road hazards and approaching emergency vehicles. Such networks could also enable emergency vehicle personnel to alert drivers to their presence, letting alerted drivers anticipate the appearance of the emergency vehicles and more quickly clear paths for them.

Ad hoc vehicle-to-vehicle networks have properties which distinguish them from other types of networks. Ad hoc vehicle-to-vehicle networks can be characterized as “personal” to network participants since, at any given time, each participant's network will consist of only those data sources (other vehicles or base stations) with which the participant is currently capable of communicating. Even in a limited geographic region, the number of different ad hoc vehicle-to-vehicle networks that can coexist is limited only by the number of participants in the region. In the following description, a participant may be characterized as the owner of the ad hoc vehicle-to-vehicle network associated with the participant.

Further, an ad hoc vehicle-to-vehicle network typically has an extremely fluid membership with other participants constantly entering and leaving the network as vehicles approach or move away from the network owner, possibly at relative speeds of 160 mph (257 kph or more. Also, other than sharing a common technological capability of participating in a vehicle-to-vehicle network, participants may have few or no common interests in how they make use of the network resources. For example, a tractor-trailer rig with a 50 foot trailer may be interested in sharing the same roadway with a subcompact hybrid sedan, but not much else.

As a consequence, much of the data generated by all participants in a vehicle-to-vehicle network may be of little use or interest to the owner of a particular ad hoc vehicle-to-vehicle network. Obsolete or uninteresting data serves only to burden the data processing system through which an ad hoc network owner participates.

### BRIEF SUMMARY OF THE INVENTION

The present invention may be implemented as a method of creating a subset of data sources in a vehicle-to-vehicle network where each participating vehicle produces a data set that can be shared with other participating vehicles on a peer-to-peer basis. Data is received from a plurality of participating vehicles. Each received data set includes associated environmental properties specific to the participating vehicle that generated the data. One or more inputs is received specifying properties of a desired subset. The environmental properties associated with each received data set are compared to the received input specifying the subset properties. A vehicle providing a data set is assigned to the subset only where a match is found between one or more of the environmental properties associated with the data set and properties defined by the received input.

The present invention may also be implemented as a computer program product for creating a subset of data sources in a vehicle-to-vehicle network in which participating vehicles produced data sets that can be shared with other participating vehicles on a peer-to-peer basis. The computer program product includes a computer usable medium embodying code configured to receive data from a plurality of participating vehicles with each received data set including associated environmental properties specific to the participating vehicle that generated the data set, code configured to receive input specifying the properties of the desired subset, code configured to compare environmental properties to properties defined by the received input, and code configured to assign a vehicle producing a data set to the subset only where a match is found between one or more of the environmental properties associated with the data set and properties defined by the received input.

The present invention may also be implemented in a system for creating a subset of data sources in a vehicle-to-vehicle network in which each participating vehicle produces a date set that can be shared with other participating vehicles on a peer-to-peer basis. A data receiving subsystem receives data from the plurality of participating vehicles. Each received data set includes associated environmental properties specific to the participating vehicle that generated the data set. An input system receives input specifying the properties of a desired subset. Compare logic compares environmental properties associated with a received data set with the specified properties of the desired subset. The vehicle providing a data set is assigned to the subset only where a match is found between at least one of its associated environmental properties and at least one of the specified properties of the desired subset.

### BRIEF DESCRIPTION OF THE SEVERAL VIEWS OF THE DRAWINGS

FIG. 1 is an illustration of several roadways traveled by cars and trucks that could participate in a vehicle-to-vehicle network of the type in which the present invention may be implemented.

FIG. 2 is an illustration of a few of the cars and trucks that appear in FIG. 1 with additional graphics representing peer-to-peer communication paths among the vehicles.

FIG. 3 illustrates one possible structure for data packets shared among participants in the vehicle-to-vehicle network.

FIG. 4 is the functional block diagram of a special purpose system that could be employed to implement the present invention.

FIG. 5 is a flow chart representing operations that would be performed in establishing a subset of data sets to be utilized in an ad hoc vehicle-to-vehicle network at a given time.

FIG. 6 illustrates a user interface screen that may be used by a network owner to specify top level choices for properties of a desired subset.

FIG. 7 illustrates a user interface screen that may be used by a network owner to specify second level choices for properties of the desired subset.

FIG. 8 illustrates a different user interface screen that may be used by a network owner to specify still other second level choices for properties of the desired subset.

FIG. 9 is a block diagram of the functional infrastructure of a programmable, general purpose computer that could be used to implement the present invention.

### DETAILED DESCRIPTION OF THE INVENTION

As will be appreciated by one skilled in the art, the present invention may be embodied as a method, system, or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product on a computer-usable storage medium having computer-usable program code embodied in the medium.

Any suitable computer usable or computer readable medium may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to the Internet, wireline, optical fiber cable, RF, etc.

Computer program code for carrying out operations of the present invention may be written in an object oriented programming language such as Java, Smalltalk, C++ or the like. However, the computer program code for carrying out operations of the present invention may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network (LAN) or a wide area network (WAN), or the connection may be made to an external computer (for example, through the Internet using an Internet Service Provider).

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

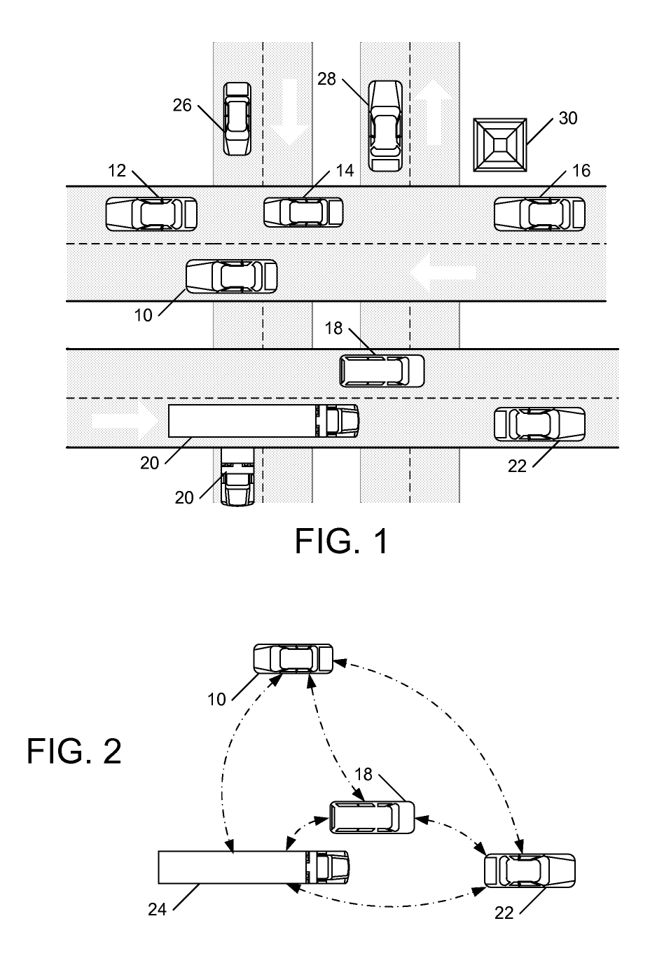

Referring to FIG. 1 and assuming that all of the vehicles shown there are properly equipped, any of the vehicles, such as car 10, may elect to participate in an vehicle-to-vehicle (V2V) network that can include not only car 10 but also cars 12, 14, and 16 that are traveling in the same direction as car 10, cars 18 and 22 and tractor-trailer 20 that are traveling in the opposite direction and even cars 26 and 28 and truck 24 that are traveling orthogonally to car 10. Being a participant in a V2V network means that each participating vehicle will be able to share both locally generated and received audio and video data as well as control data with other participating vehicles.

As a practical matter, roadside base stations, such as base station 30, may be considered participants in V2V networks by receiving data from and providing data to vehicles in the network even though the base stations obviously do not satisfy any conventional definition of the word “vehicle”.

Referring to FIG. 2, communications among participating vehicles are preferably conducted on a peer-to-peer basis that enables any vehicle in the network to wirelessly communicate directly with any other participating vehicle within a predetermined range determined by the wireless protocol implemented by the network. As noted earlier, the Dedicated Short Range Communications wireless protocol developed for automotive applications has an effective range on the order of 100 to 300 meters, which would be sufficient to enable car 10 to communicate directly with at least cars 18 and 22 and tractor-trailer 20 along with other nearby vehicles (not shown).

As noted earlier, multiple ad hoc vehicle-to-vehicle networks can coexist even in a limited geographic area. Every participant in a vehicle-to-vehicle network may be considered to be the “owner” of a personal, ad hoc vehicle-to-vehicle network consisting of vehicles or other data sources capable of sharing data with the participant.

The size of the ad hoc network from the perspective of car 10 (or any other participant in the network) is not limited to vehicles with which car 10 may communicate directly. Each participating vehicle can act as a relay point, receiving data from a nearby vehicle and passing it on to other vehicles that are within the direct communication range of the relaying vehicle regardless of whether the target vehicles are beyond the direct communication range of the vehicle from which the data originated. Thus, data can radiate along chains of vehicles, only one or a few of which may be within the direct communication range of the data source.

However, the fact that a given participant can receive data from many other participants at any given time does not necessarily mean that given participant has any need for or interest in all the data it is capable of receiving. The present invention enables an owner of an ad hoc vehicle-to-vehicle network to efficiently pursue the goal of gathering and processing only useful information by defining a swarm of active data sources; i.e., a subset of data that will actually be processed for the owner's use at any given time.

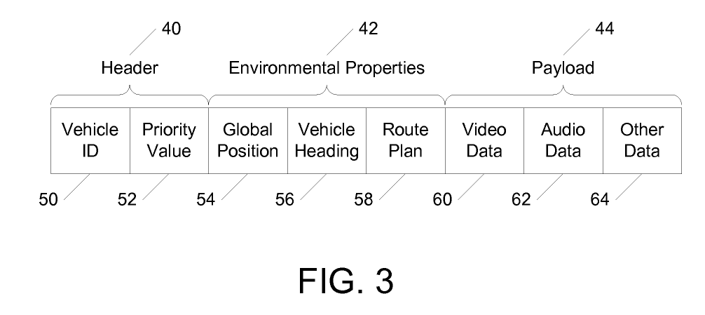

FIG. 3 illustrates a possible structure for data packets that, when shared among participants in a vehicle-to-vehicle network, support implementation of the present invention. The packet structure includes three major set of fields: header fields 40; environmental property fields 42; and payload fields 44. The header fields 40 include a source identification (ID) field 50 containing a globally unique identifier for the source (vehicle or base station) of the data packet and a priority value field 52, the content of which determines how the packet will be treated in the receiving vehicle. The number of possible different priority values and the definitions of when they are to be used will be established by the administrators of the vehicle-to-vehicle network or possibly by a standards authority. As few as two priority values might be used with a priority value of “0” being assigned to normal data and the priority value of “1” being assigned to emergency or overriding data.

The environmental properties fields 42 can include a global position field 52 containing the current global coordinates of the data source derived from a global positioning system associated with the source, a vehicle heading field 56 that indicates the direction in which the vehicle is traveling expressed as a compass heading, and a route plan field 58 containing information about the projected route of the vehicle. The data in the vehicle heading field 56 may either be derived from changes in the global coordinates of the vehicle or from an in-vehicle digital compass. The data in the route plan field 58 may be entered explicitly by the vehicle driver or derived from an in-vehicle navigation system which the driver previously programmed by entering one or more intended destinations.

Other environmental property fields, although not shown, may exist in the packet structure. For example, environmental properties fields may be dedicated to current vehicle speed, outside temperatures, sensed precipitation, vehicle types, etc.

The payload fields 44 can include a video data field 60, an audio data field 62 and an “other” data field 64. The video data fields 60 may include video generated by one or more video cameras mounted on or associated with the data source. Similarly, the audio data field 62 may include audio data generated at the data source; e.g., a voiced message from the operator of the source vehicle. The “other” data in the field 64 may include control data used in administration of the vehicle-to-vehicle network.

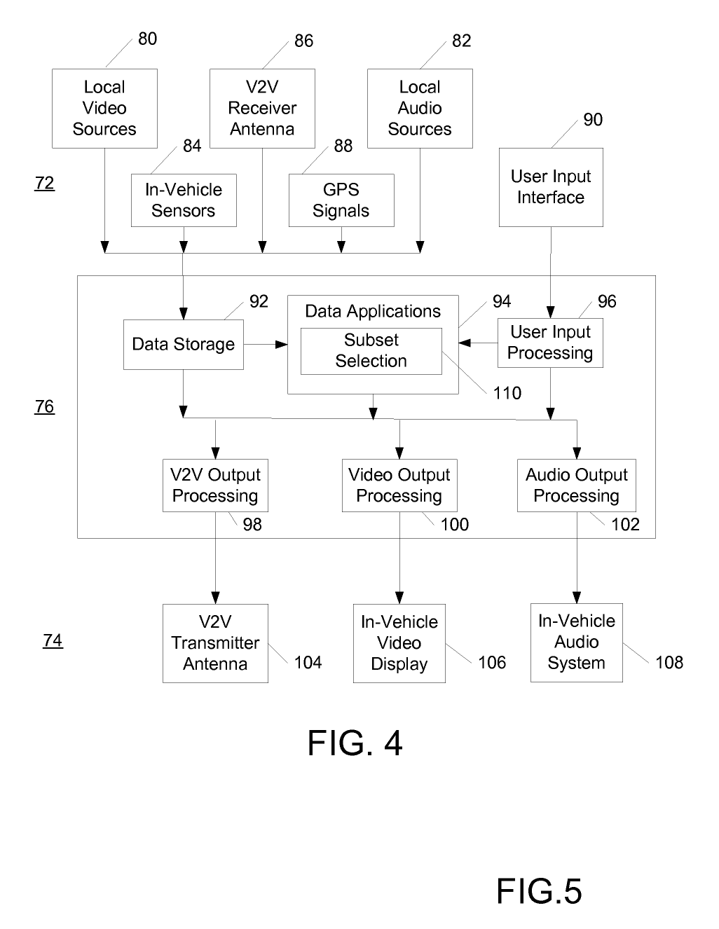

FIG. 4 is a functional block diagram of the major functional components for a data processing system used by each participant in a vehicle-to-vehicle network. The data processing system can be roughly divided into three major subsystems: an input subsystem 72, an output subsystem 74, and a data processing subsystem 76 that processes incoming data provided by the input subsystem 72 to provide the output data utilized by the output subsystem 74.

The input subsystem 72 includes local video sources 80 such as vehicle-mounted video cameras of the type already discussed and local audio sources 82, including such sources as vehicle-mounted microphones for capturing voice input from drivers and/or passengers or Bluetooth or other wireless protocols that support the capture of such voice input from wireless headsets used by drivers and/or passengers. The input subsystem 72 further includes connections to in-vehicle sensors 84, an obvious example of which is the vehicle speedometer, and to a GPS or Global Positioning System subsystem 88 that provides the vehicle's current global location.

The input subsystem 72 further includes a user input interface 90 for acquiring user data and commands. The user input interface can be implemented in a number of known ways. Key input technologies, touchscreen technologies and voice recognition technologies are nonexclusive examples of technologies that can be employed to capture user input.

All of the input subsystems described above can be characterized as local subsystems in that they capture data originating at the vehicle itself. The essence of a V2V network is that each vehicle participating in the network can make use of data provided by other participating vehicles. To make that possible, the input subsystem 72 must include a V2V receiver antenna 86 to acquire audio, video and other data from other vehicles participating in the V2V network.

Input data, both local and remote, is at least initially stored in a data storage subsystem 92 in the data processing subsystem 76. Stored data is retrieved from storage for use by data applications 94 that may be invoked by the vehicle driver or passengers using commands entered at the interface 90 and processed in a user input processing subsystem 96.

Output data resulting from execution of data applications in subsystem 94 may be made available to other participating vehicles through the use of a V2V output processing subsystem 98 connected to a V2V transmitter antenna 104. Depending upon the technologies employed, V2V transmitter antenna 104 and V2V receiver antenna 86 may be the same physical device. Output data may, of course, be used within the vehicle as well. Data intended for an in-vehicle video display 106 undergoes processing in a video output processing stage 100 before being directed to the display. Similarly, data intended for the in-vehicle audio system 108 is processed in an audio output processing stage 102 before being sent to the audio system.

In the illustrated data processing system, the logic for in enabling the owner of an ad hoc vehicle-to-vehicle network to define a subset or swarm of active data sources resides in a subset selection module 110 that is part of the data applications section 94. The operations performed by the subset selection module 110 will be described in detail below.

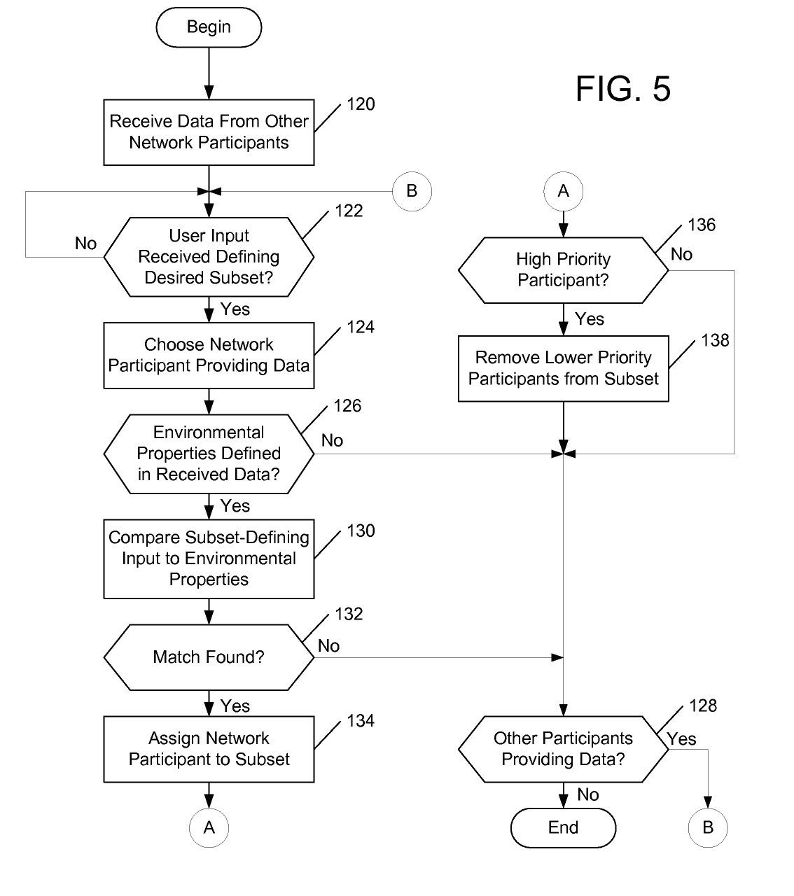

FIG. 5 is a flow chart of operations that are performed in the data processing system previously described with reference to FIG. 4 in implementing the present invention. For purposes of the flowchart, it is assumed that the data processing system has already been activated and is operating normally.

As part of the normal system operation, video data streams generated by other participants in the vehicle-to-vehicle network are received and stored at least temporarily (operation 120) on an on-going basis without regard to whether that data will eventually be used in the receiving vehicle An operation 122 determines whether the operator of the receiving vehicle has provided any input defining the subset of data sources that will be actively used by the receiving vehicle. If the operator has provided no such input, the process of defining the subset is not initiated. If, however, the operator has provided such input, one of the current data sources or network participants is chosen in an operation 124 and a check 126 is made for any environmental properties specified in a data packet received from the chosen source. If the received data packet specifies no environmental properties, the chosen source is not considered eligible for inclusion in the subset and an immediate check 128 is made to determine whether other participants must be evaluated to determine whether they should be included in the subset. If all possible participants have been evaluated, the process ends. Otherwise, process loops back to the input of operation 122.

If the operation 126 shows that environmental properties are specified in the received data packet, the environmental properties are compared to subset-defining inputs in an operation 130. If at least one of the environmental properties specified in the received data packet matches at least one of the subset-defining inputs (operation 132), the network participant that was the original source of the data packet is assigned to the desired subset. If no matches were found, the network participant is ignored and the check 128 for other network participants to be considered is performed.

Once the network participant is assigned to the subset, the priority value field of the data packet provided by that participant is examined (operation 136) to determine whether the packet is an overriding or high-priority packet that is to be given precedence over all other received data packets. Once a high-priority packet is identified, the subset is limited to high-priority participants by removing lower priority participants from the subset in an operation 138. Since there may be more than one high-priority participant at a given time, the process of considering other participants (beginning at operation 128) continues to be performed even after the first high-priority participant is identified.

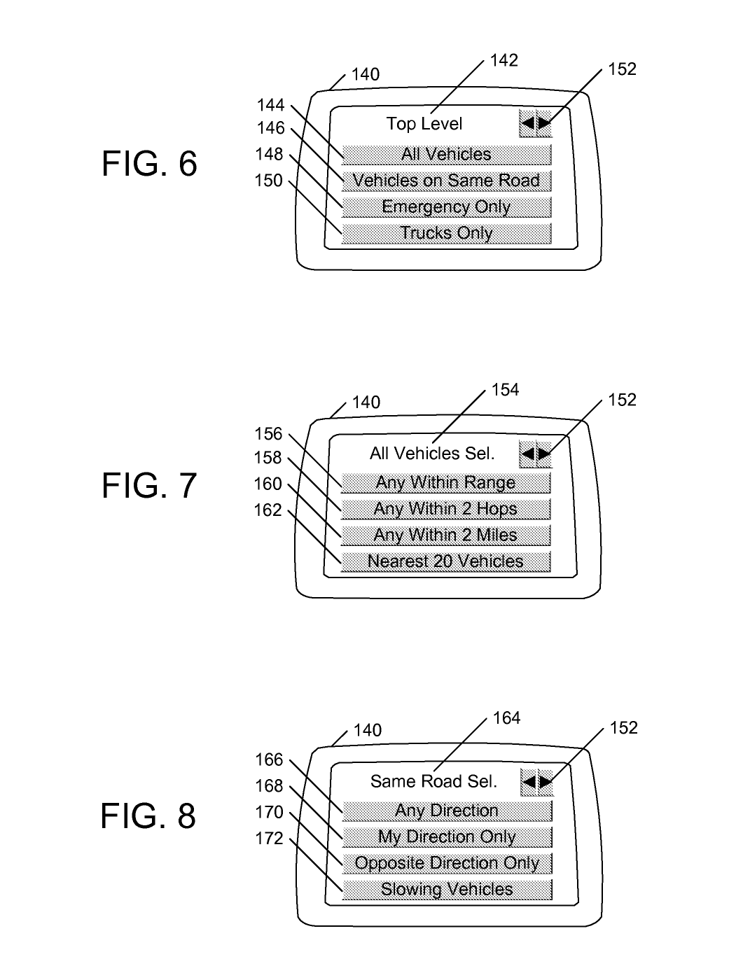

The practicality of the present invention clearly hinges on how easily a network participant can specify the characteristics of data sources that are to be included in the desired subset. FIGS. 6 through 8 depict a user input device 140 that enables a network participant to easily enter the desired characteristics of the subset. In one embodiment, device 140 employs touchscreen technology and programmable “soft” buttons that, when touched, register the participant's choice.

Referring first to FIG. 6, the subset definition process is initiated using the top-level menu, indicated by header 142, that enables the user to make a high-level selection of the type of vehicles that are eligible for the subset. As examples, the user may elect to extend eligibility to all vehicles (button 144), only vehicles on the same road (button 146), only emergency vehicles (button 148), or to trucks only (button 150), the latter choice obviously being one of most interest to other truckers. The screen may also include a set of spin buttons 152 to enable the user to page forward or backward to other screens.

If the user has selected the “All Vehicles” option in the top-level menu, the user may still wish to refine that selection by using a second-level menu of the type shown in FIG. 7. The header 154 of the second-level menu will identify the prior selection and present choices for refining that selection. For example, the user may specify selection eligibility is to extend to any vehicles within range (button 156), to any vehicles within two hops from the user's vehicle (button 158), to all vehicles within a certain distance (e.g., 2 miles) of the user's vehicle (button 160), or to the nearest 20 vehicles (button 162). Obviously, other choices could be made or slightly different soft button sequences could be used. For example, a screen choice could enable a user to select the nearest X number of vehicles, with a follow on screen enabling the user to specify a value for X.

FIG. 8 depicts a different second-level menu that could be invoked if the user had previously selected the “Vehicles on Same Road” option on the top-level menu. A header 164 will identify the previous selection and present further refining choices to the user. As examples, the user could refine the choices to vehicles traveling any direction but on the same road (button 166), vehicles traveling in the same direction on the same road (button 168), vehicles traveling in the opposite direction but on the same road (button 170), or only vehicles that are decelerating but on the same road (button 172). The last choice is one a user would be most likely to make when trying to find out why a traffic slowdown is occurring.

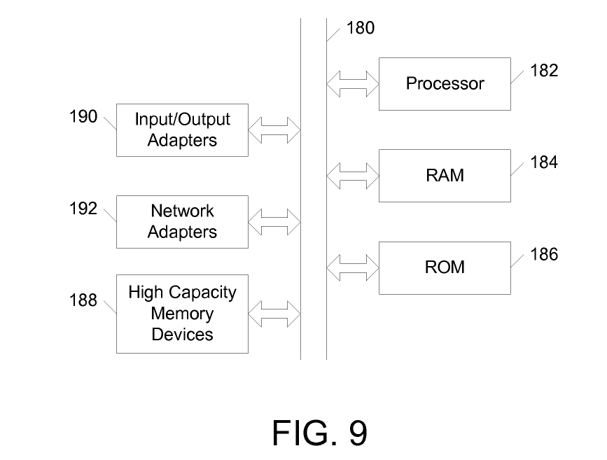

The invention may be implemented through the use of special-purpose hardware of the type functionally described earlier. Alternatively, the invention may be implemented by programming a general purpose computer device having an infrastructure of the type illustrated in FIG. 9. The infrastructure includes a system bus 180 that carries information and data among a plurality of hardware subsystems including a processor 182 used to execute program instructions received from computer applications running on the hardware. The infrastructure also includes random access memory (RAM) 184 that provides temporary storage for program instructions and data during execution of computer applications and are read only memory (ROM) 186 often used to store program instructions required for proper operation of the device itself, as opposed to execution of computer applications. Long-term storage of programs and data is provided by high-capacity memory devices 188, such as magnetic hard drives or optical CD or DVD drives.

In a typical computer system, a considerable number of input/output devices are connected to the system bus 170 through input/output adapters 190. Commonly used input/output devices include monitors, keyboards, pointing devices and printers. Increasingly, high capacity memory devices are being connected to the system through what might be described as general-purpose input/output adapters, such as USB or FireWire adapters. Finally, the system includes one or more network adapters 192 that are used to connect the system to other computer systems through intervening computer networks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated. For example, while the provided description assumes that a primary data set is generated by a video camera mounted on a vehicle being used by the user who wants to build a simulated view, it is well within the scope of the invention for the user to be able to identify any video camera in the V2V network as the primary video camera, to build a simulated view using the identified video camera and transport that simulated view for presentation on a video display in his own vehicle. Moreover, while the invention has been described for use in a V2V network, it obviously has applicability to other networks where multiple video cameras may share video data; e.g., multi-camera video surveillance systems.

Having thus described the invention of the present application in detail and by reference to preferred embodiments thereof, it will be apparent that modifications and variations are possible without departing from the scope of the invention defined in the appended claims.

What is claimed is:

1. A method of creating a subset of data sources in a vehicle-to-vehicle network wherein each of a plurality of participating vehicles produces a data set that can be shared with other participating vehicles on a peer-to-peer basis, said method comprising:
receiving data from a plurality of participating vehicles, each received data set including environmental properties specific to the participating vehicle that generated the data;
receiving an input specifying the properties of a desired subset;
comparing environmental properties in each received data set to properties defined by the received input; and
assigning a vehicle to the subset only where a match is found between one or more of the compared environmental properties in the data set provided by the vehicle and properties defined by the received input.

2. A method according to claim 1 further comprising processing data provided only by vehicles assigned to the subset.

3. A method according to claim 2 wherein the received input specifying the properties of a desired subset is provided by a user of a vehicle receiving data sets from the plurality of participating vehicles.

4. A method according to claim 2 wherein said environmental properties include at least one of the direction of travel of the vehicle providing the data, the global coordinates of the vehicle providing the data and the planned route of the vehicle providing the data.

5. A method according to claim 3 wherein said environmental properties include at least one of the direction of travel of the vehicle providing the data, the global coordinates of the vehicle providing the data and the planned route of the vehicle providing the data.

6. A method according to claim 4 wherein the properties defined by the received input include at least one of vehicles traveling in the same direction as the vehicle receiving the data, vehicles traveling in the opposite direction as the vehicle receiving the data, vehicles ahead of the vehicle receiving the data, vehicles behind the vehicle receiving the data, vehicles within a predetermined distance of the vehicle receiving the data and vehicles providing a data stream having a high priority identifier.

7. A method according to claim 5 wherein the properties defined by the received input include at least one of vehicles traveling in the same direction as the vehicle receiving the data, vehicles traveling in the opposite direction as the vehicle receiving the data, vehicles ahead of the vehicle receiving the data, vehicles behind the vehicle receiving the data, vehicles within a predetermined distance of the vehicle receiving the data and vehicles providing a data stream having a high priority identifier.

8. A computer program product for creating a subset of data sources in a vehicle-to-vehicle network wherein each of a plurality of participating vehicles produces a data set that can be shared with other participating vehicles on a peer-to-peer basis, said computer program product comprising a computer usable medium having computer usable program code embodied therewith, said computer usable program code comprising:
computer usable program code configured to receive data from a plurality of participating vehicles, each received data set including environmental properties specific to the participating vehicle that generated the data;
computer usable program code configured to receive an input specifying the properties of a desired subset;
computer usable program code configured to compare environmental properties in each received data set to properties defined by the received input; and
computer usable program code configured to assign a vehicle to the subset only where a match is found between one or more of the compared environmental properties in the data set provided by the vehicle and properties defined by the received input.

9. A computer program product according to claim 8 further comprising computer usable program code configured to process data provided only by vehicles assigned to the subset.

10. A computer program product according to claim 9 wherein the received input specifying the properties of a desired subset is provided by a user of a vehicle receiving data sets from the plurality of participating vehicles.

11. A computer program product according to claim 9 wherein said environmental properties include at least one of the direction of travel of the vehicle providing the data, the global coordinates of the vehicle providing the data and the planned route of the vehicle providing the data.

12. A computer program product according to claim 10 wherein said environmental properties include at least one of the direction of travel of the vehicle providing the data, the global coordinates of the vehicle providing the data and the planned route of the vehicle providing the data.

13. A computer program product according to claim 1I1 wherein the properties defined by the received input include at least one of vehicles traveling in the same direction as the vehicle receiving the data, vehicles traveling in the opposite direction as the vehicle receiving the data, vehicles ahead of the vehicle receiving the data, vehicles behind the vehicle receiving the data, vehicles within a predetermined distance of the vehicle receiving the data and vehicles providing a data stream having a high priority identifier.

14. A method according to claim 12 wherein the properties defined by the received input include at least one of vehicles traveling in the same direction as the vehicle receiving the data, vehicles traveling in the opposite direction as the vehicle receiving the data, vehicles ahead of the vehicle receiving the data, vehicles behind the vehicle receiving the data, vehicles within a predetermined distance of the vehicle receiving the data and vehicles providing a data stream having a high priority identifier.

15. In a vehicle-to-vehicle network in which each of a plurality of participating vehicles produces a data set that can be shared with other participating vehicles on a peer-to-peer basis, a system for creating a subset of data sources providing data to be processed comprising:
a data receiving subsystem for receiving data from the plurality of participating vehicles, each received data set including environmental properties specific to the participating vehicle that generated the data;
an input system for receiving input specifying the properties of a desired subset;
compare logic for comparing environmental properties included in a received data set to input specifying the properties of a desired subset;
subset creating logic for assigning a vehicle to the desired subset only where a match is found between one or more of the compared environmental properties in the data set provided by the vehicle and properties defined by the received input.

16. A system according to claim 15 further comprising data processing logic processing data provided only by vehicles assigned to the subset.

17. A system according to claim 16 wherein the received input specifying the properties of a desired subset is provided by a user of a vehicle receiving data sets from the plurality of participating vehicles.

18. A method according to claim 16 wherein said environmental properties include at least one of the direction of travel of the vehicle providing the data, the global coordinates of the vehicle providing the data and the planned route of the vehicle providing the data.

19. A method according to claim 17 wherein said environmental properties include at least one of the direction of travel of the vehicle providing the data, the global coordinates of the vehicle providing the data and the planned route of the vehicle providing the data.
